(19) United States
(12) Patent Application Publication
(10) Pub. No.: US 2023/0110558 A1
(43) Pub. Date: Apr. 13, 2023

(54) SYSTEMS AND METHODS FOR DETECTING OBJECTS

(71) Applicant: Cognex Corporation, Natick, MA (US)

(72) Inventors: Zihan Hans Liu, Cambridge, MA (US); Philippe Hanhart, Vevey (CH); Reto Wyss, Lexington, MA (US); Simon Alaric Barker, Sudbury, MA (US)

(73) Assignee: Cognex Corporation, Natick, MA (US)

(21) Appl. No.: 17/961,711

(22) Filed: Oct. 7, 2022

Related U.S. Application Data
(60) Provisional application No. 63/253,496, filed on Oct. 7, 2021.

(51) Int. Cl. G06T 7/70; G06V 10/77; G06V 10/764; G06V 20/70; G06V 10/774; G06T 5/00; G06T 7/00; G06V 20/50

(52) U.S. Cl. CPC G06T 7/70; G06V 10/7715; G06V 10/764; G06V 20/70; G06V 10/774; G06T 5/002; G06T 7/0004; G06V 20/50; G06T 2207/20081; G06T 2207/30108

(57) ABSTRACT

The techniques described herein relate to computerized methods and apparatuses for detecting objects in an image. The techniques described herein further relate to computerized methods and apparatuses for detecting one or more objects using a pre-trained machine learning model and one or more other machine learning models that can be trained in a field training process. The pre-trained machine learning model may be a deep machine learning model.

### RELATED APPLICATIONS

This Application claims priority under 35 U.S.C. § 119(e) to U.S. Provisional Application Ser. No. 63/253,496, titled “SYSTEMS AND METHODS FOR DETECTING OBJECTS,” filed on Oct. 7, 2021, which is herein incorporated by reference in its entirety.

### FIELD

This technology relates to machine vision systems and methods, and more particularly to systems and methods for detecting objects.

### BACKGROUND

It can be desirable to detect objects, such as characters, in an image. Various techniques can be used to detect objects in an image. Optical character recognition (OCR) technology, for example, is often used in many machine vision systems in order to detect text associated with various manufacturing processes, such as text printed on and/or affixed to machine parts. However, setting up parameters for a given OCR application can be difficult, especially for new users. For example, for character recognition, a user may select a region around an OCR character string to indicate to the machine vision system where the characters are for the OCR process. If the system does not recognize the characters correctly, it can be difficult for the user to manually troubleshoot the problem. Further, unlike some applications where such problems can be solved in advance (e.g., by a system integrator), adjusting parameters as part of a manufacturing process often requires technicians or engineers to troubleshoot such problems on the actual production floor (e.g., to train or modify the runtime parameters to provide for better OCR). Such training or adjustment may be required, for example, when manufacturing new parts, or using new printing or labels.

### SUMMARY

The present disclosure relates to techniques for detecting objects, such as characters, in an image. Some aspects of the described techniques provide for a computerized method, a non-transitory computer-readable media and/or a system for recognizing one or more objects in an image. The method includes determining a feature map of the image. The method may use a pre-trained machine learning model to determine the feature map. The pre-trained machine learning model may be a deep machine learning model. The method further includes processing the feature map of the image using a first machine learning model to generate an object center heatmap for the image, where the object center heatmap includes a plurality of samples each having a value indicative of a likelihood of a corresponding sample in the image being a center of an object. The method further include determining locations of one or more objects in the image based on the object center heatmap. In some examples, the method may additionally include processing the locations of the one or more objects in the image using a second machine learning model and the feature map to recognize at least one object of the one or more objects. The first and the second machine learning models may be trained in a field training process.

In some embodiments, recognizing at least one object of the one or more objects includes: generating an object feature vector using a portion of the feature map of the image, wherein the portion of the feature map is based on an area surrounding the location of the object; processing the object feature vector using the second machine learning model to generate a class vector, wherein the class vector includes a plurality of values each corresponding to one of a plurality of known labels; and classifying the object to a label of the plurality of known labels using the class vector.

In some embodiments, each value of the class vector is indicative of a predicted score associated with a corresponding one of the plurality of known labels, and, classifying the object includes selecting a maximum value among the plurality of values in the class vector, wherein the selected value corresponds to the label.

In some embodiments, the plurality of known labels includes a plurality of textual character labels.

In some embodiments, the plurality of known labels further includes a background label.

In some embodiments, the method further includes training each of the first machine learning model and the second machine learning model using a respective machine learning method and using a respective set of field training data.

In some embodiments, the one or more objects include one or more printed textual characters on a part contained in the image; and the method further includes tracking the part using at least one textual character recognized from the one or more textual characters.

In some embodiments, determining the locations of the one or more objects includes: smoothing the object center heatmap to generate a smoothed object center heatmap; and selecting the locations of the one or more objects, wherein a value at each respective location in the smoothed object center heatmap is higher than values in a proximate area of the location.

In some embodiments, smoothing the object center heatmap includes applying a Gaussian filter having a standard deviation proportional to an object size.

In some embodiments, selecting the location further includes filtering one or more locations at which the value in the smoothed object center heatmap is below a threshold.

In some embodiments, the first machine learning model includes a weight vector; the feature map of the image includes a plurality of samples each associated with a respective feature vector; and a value of each sample in the object center heatmap is a dot product of a feature vector of a corresponding sample in the feature map and a weight vector.

In some embodiments, determining the feature map of the image includes: processing the image using a pre-trained neural network model to generate the feature map of the image.

In some embodiments, the method further includes capturing the image using a 1D barcode scanner or a 2D barcode scanner.

In some embodiments, a non-transitory computer-readable media is provided that includes instructions that, when executed by one or more processors on a computing device, are operable to cause the one or more processors to execute any of the method described above.

In some embodiments, a system is provided that includes: a scanner including an image capturing device configured to capture an image of a part on an inspection station; and a processor configured to execute programming instructions to perform operations including any of the method described above.

Some aspects of the described techniques provide for a computerized method, a non-transitory computer-readable media and/or a system for recognizing one or more characters in an image. In some embodiments, a method includes processing the image using a pre-trained machine learning model to generate a feature map of the image; processing the feature map of the image using a first machine learning model to generate a character center heatmap for the image, wherein the character center heatmap includes a plurality of samples each having a value indicative of a likelihood of a corresponding sample in the image being a center of a character; and processing the feature map of the image and the character center heatmap for the image using a second machine learning model to recognize one or more characters in the image.

In some embodiments, recognizing at least one character of the one or more characters includes: generating a character feature vector using the feature map of the image and the character center heatmap of the image; processing the character feature vector using the second machine learning model to generate a class vector, wherein the class vector includes a plurality of values each corresponding to one of a plurality of known labels; and classifying the character to a label of the plurality of known labels using the class vector.

In some embodiments, each value of the class vector is indicative of a predicted score associated with a corresponding one of the plurality of known labels, and, classifying the character includes selecting a maximum value among the plurality of values in the class vector, wherein the selected value corresponds to the label.

In some embodiments, the plurality of known labels further includes a background label.

In some embodiments, the method further includes determining locations of the one or more characters in the image based on the character center heatmap, wherein generating the character feature vector for the at least one character includes generating the character feature vector using a portion of the feature map of the image, wherein the portion of the feature map is based on an area surrounding the location of the character.

In some embodiments, determining the locations of the one or more characters includes: smoothing the character center heatmap to generate a smoothed character center heatmap; and selecting the locations of the one or more characters, wherein a value at each respective location in the smoothed character center heatmap is higher than values in a proximate area of the location.

In some embodiments, smoothing the character center heatmap includes applying a Gaussian filter having a standard deviation proportional to a character size.

In some embodiments, selecting the location further includes filtering one or more locations at which the value in the smoothed character center heatmap is below a threshold.

In some embodiments, the first machine learning model includes a weight vector; the feature map of the image includes a plurality of samples each associated with a respective feature vector; and a value of each sample in the character center heatmap is a dot product of a feature vector of a corresponding sample in the feature map and a weight vector.

In some embodiments, the method includes training the second machine learning model by: obtaining a plurality of training images and a plurality of training labels, each of the plurality of training labels associated with a character in a corresponding one of the plurality of training images; determining a plurality of training feature maps respectively using one of the plurality of training images and the pre-trained machine learning model; and determining weights of the second machine learning model using the plurality of training feature maps and the plurality of training labels.

In some embodiments, determining the weights of the second machine learning model includes: (1) for each training label of the plurality of training labels: determining a corresponding character feature vector using a portion of the feature map of the corresponding training image with which the training label is associated; and determining a target vector; and (2) determining the weights of the second machine learning model using the character feature vectors and the target vectors of the plurality of training labels.

In some embodiments, determining the weights of the second machine learning model includes using a machine learning method on the character feature vectors and the target vectors.

In some embodiments, the method further includes: for each training label of the plurality of training labels: (1) obtaining a location of the training label in the corresponding training image; and (2) determining the corresponding character feature vector using the portion of the feature map of the corresponding training image based on the location of the training label.

In some embodiments, the portion of the feature map is represented by a bounding box centered about the location of the training label in the corresponding training image.

In some embodiments, determining the corresponding character feature vector includes concatenating a plurality of sub-feature vectors each formed based on a respective position in the portion of the feature map.

In some embodiments, the method further includes training the first machine learning model by: determining a plurality of ground truth character center heatmaps of a plurality of training feature map; and determining weights of the first machine learning model using the plurality of training feature maps and the plurality of ground truth character center heatmaps.

In some embodiments, determining the weights of the first machine learning model includes determining the weights of the first machine learning model using a machine learning method.

In some embodiments, determining the plurality of ground truth character center heatmaps includes a plurality of samples each having a value based on a distance to a nearest ground truth location of training labels in the training images.

In some embodiments, the method further includes: via a graphical user interface, receiving a one-to-one mapping between a character in the plurality of training images and a character label for each of one or more characters in the plurality of training images; and generating the plurality of training labels based on the received one-to-one mappings for the one or more characters in the plurality of training images.

In some embodiments, the method further includes: via the graphical user interface, receiving a correction to one or more recognized characters; updating the plurality of training labels based on the correction; and re-training the first machine learning model and the second machine learning model further based on the updated plurality of training labels.

In some embodiments, the one or more characters include one or more printed textual characters on a part contained in the image; and the method further includes tracking the part using at least one textual character recognized from the one or more textual characters.

In some embodiments, a non-transitory computer-readable media is provided that includes instructions that, when executed by one or more processors on a computing device, are operable to cause the one or more processors to execute the any of the method described above.

In some embodiments, a system is provided that includes: a scanner including an image capturing device configured to capture an image of a part on an inspection station; and a processor configured to execute programming instructions to execute any of the method described above.

It should be appreciated that all combinations of the foregoing concepts and additional concepts described in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

Additional embodiments of the disclosure, as well as features and advantages thereof, will become more apparent by reference to the description herein taken in conjunction with the accompanying drawings. The components in the figures are not necessarily to scale. Moreover, in the figures, like-referenced numerals designate corresponding parts throughout the different views.

FIG. 1 is a diagram of a system for detecting objects, according to some embodiments of the technologies described herein.

FIG. 2 is another diagram of a system for detecting objects, according to some embodiments of the technologies described herein.

FIG. 3 is a flowchart of an illustrative process for detecting objects, according to some embodiments of the technologies described herein.

FIG. 4 is a flowchart of an illustrative process for detecting characters, according to some embodiments of the technologies described herein.

FIG. 5A is a flowchart of an illustrative process for training a machine learning model to be used in detecting characters, according to some embodiments of the technologies described herein.

FIG. 5B is a flowchart of an illustrative process for training another machine learning model to be used in detecting characters, according to some embodiments of the technologies described herein.

FIG. 6 is an example part including characters printed thereon that can be detected, according to some embodiments of the technologies described herein.

FIG. 7 shows an example graphical user interface for correcting labels in a training process, according to some embodiments of the technologies described herein.

FIG. 8 shows an illustrative implementation of a computer system that may be used to perform any of the aspects of the techniques and embodiments disclosed herein, according to some embodiments of the technologies described herein.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the invention is thereby intended.

It can be desirable to detect objects, such as characters, in an image for various machine vision applications. For example, it can be desirable to detect text printed on and/or affixed to machine parts as part of a manufacturing or inspection process. Various techniques can be used to detect objects for machine vision applications. As an example, an OCR application in a manufacturing process may include recognizing a printed label having one or more textual characters that depict a part number. In the application, an image that includes a part having a printed label may be captured. The OCR technology may be used to determine the locations of one or more characters in the printed label and recognize the characters. The inventors have recognized and appreciated that applying conventional object detection technologies to the manufacturing process described above is particular challenging, and that such conventional techniques may be improved upon. For example, images captured during the manufacturing process may be of low quality (e.g., as compared to scanned documents) in a conventional object detection system because of various conditions in which the images are captured. Examples of these various conditions may include, for example, motion of the parts to be captured in the scene, the distance between the camera and the parts, unknown or uncontrollable poses of the parts in the scene, and/or the lighting conditions of the parts in the scene. Such conditions may affect, for example, the contrast of the images. For characters, for example, the distance between the camera and the parts may affect the character sizes in the images. As another example, the variations in the location of the printed labels on a part may affect the location of the characters in the captured image. These various conditions and other conditions during the manufacturing process have created difficulties in applying such conventional technologies.

Some object detection systems are designed to adapt to a particular application or the environment in which the application is run by training certain system parameters. Training data to be used to train the system parameters are collected from a target application domain. For example, training data may be collected or generated in a laboratory environment that simulates conditions under which the system is to be deployed. However, this approach suffers several drawbacks. First, the environment in which the object detection system is trained and developed (e.g., in a laboratory environment) may be quite different than the environment in which the object detection system is deployed in the field. Second, collecting training data for a particular application or environment may be costly.

Some object detection systems, such as OCR systems, are designed to be adaptable to certain applications to provide improved object detection performance by allowing users to adjust certain parameters. However, these systems have drawbacks because adjusting the parameters usually requires a system integrator, a technician, or even someone with the knowledge of how an object detection system works. For example, in a typical system, there may be 20-30 parameters that might require adjustment. Adjusting these parameters may be beyond the level of skills of most users.

Some object detection systems use machine learning techniques. For example, deep machine learning techniques have been used in OCR systems to detect characters from an image. However, the inventors have recognized and appreciated that conventional systems for object recognition that use machine learning techniques typically offer little or no flexibility in being able to adjust the machine learning models being used during deployment. For example, machine learning (e.g., deep machine learning) techniques inherit the same drawbacks as discussed previously because machine learning techniques generally require a large training dataset, such as hundreds, thousands, or tens of thousands of training images and associated ground truth data (e.g., providing information on the object(s) contained in the images). Such large training data sets may be difficult and/or expensive to collect. Additionally, when a deep machine learning technique is used, the training process may even be extremely time consuming given the large number of images and the large number of weights in a deep machine learning model. For example, in a convolutional neural network (CNN), there may be tens of thousands of weights. Thus, it is generally infeasible to deploy these machine learning-based techniques in a manner that provides for adapting the machine learning model in the field. Once in the field, there may not be sufficient training data and/or computing resources to train and/or retrain these systems in a reasonable period of time (e.g., fast enough so that the training or adjustment process does not result in a poor user experience).

Further, the inventors have recognized and appreciated that conventional machine learning-based systems often use a black-box approach to process an image from end to end. For example, conventional systems may provide for receiving an image as an input and generating object detection results as an output, such as OCR results, but do not provide any visibility into the machine learning model(s) and/or other parts of the processing pipeline that is used to generate the object detection results. Additionally or alternatively, such systems do not provide for recognizing individual objects when multiple objects are present in a scene. For example, OCR systems do not provide for recognizing individual characters of a character string or generating intermediate results or data of the processing pipeline, such as providing data indicative of the locations of characters in the image that are being OCR'd (e.g., which in-turn can be used to configure the OCR process). Instead, these systems typically just provide for recognizing a block of text, such as a line or multiple lines of text in an image.

Accordingly, the inventors have developed techniques described herein to provide an object detection system that can be easily and quickly trained in the field. In some embodiments, a system may be provided to include one or more machine learning models that can be trained in the field. As opposed to using a complex machine learning model in a black-box approach, using multiple machine learning models may allow the system to use smaller and simpler machine learning models, each focusing on extracting certain features of the image.

Object detection may include an operation for detecting one or more objects in an image, a video, and/or any other suitable media asset. Examples of object detection may include determining one or more objects and/or recognizing the objects in an image, a video, and/or any other suitable media asset. For example, in a manufacturing process in which an image may include one or more machine parts traveling on an assembly line, object detection may include locating one or more parts in the image. Object detection may also include recognizing the one or more parts and a respective known class corresponding to each of the recognized parts.

It is appreciated that one or more objects in an image may include various types of items. Further examples of an object to be detected from an image may include text (e.g., a character in a printed label), graphics, a symbol, an icon, a barcode, a machine, a human face, an animal, a piece of furniture, a sign, a landmark, or any other suitable text/graphical representation, or a combination thereof. The object contained in an image may include any color or a combination of multiple colors. A textual character may be in English, or any other suitable language. Thus, the techniques described herein may apply to detecting various types of items, including characters in an image. A character may include any symbols whether textual or graphics. Examples of a character may include any character in ASCII set, alphabets in any suitable language, or non-textual symbols, e.g., mathematical symbols or other symbols.

Accordingly, the described techniques include systems, computerized methods, and non-transitory instructions, that process an image to detect one or more objects in the image. In some embodiments, the system may obtain an image containing one or more objects and process the image to determine a feature map of the image using a pre-trained machine learning model. In some examples, the pre-trained machine learning model may be a deep machine learning model, such as a convolutional neural network (CNN) having one or more hidden layers, or any other suitable model. The pre-trained machine learning model may be configured to encode some features of the image for subsequent processing to output a feature map. The feature map may include a plurality of samples, each including a vector (e.g., a feature vector) having multiple values that encode semantic information about the image at each respective position. The size of the feature map may be different from that of the image. For example, the feature map may be smaller than the image, with its size at ¼, or ⅛ of the size of the image.

In some embodiments, the system may further process the feature map of the image using a first machine learning model to generate an object center heatmap for the image. The first machine learning model may be trained in a field training process. An object center heatmap may be a representation of an image that depicts the likelihood of one or more pixels in the image being a center of an object. For example, the object center heatmap may include a plurality of samples each having a value indicative of a likelihood of a corresponding sample in the image being a center of an object. Thus, samples near a center of an object in an image may have higher values in the object center heatmap than samples in other areas in the image. In some examples, the first machine learning model may include a weight vector comprising a plurality of weights in a vector. The size of an object center heatmap may have the same size as the feature map. In some embodiments, a value of each sample in the object center heatmap may be a dot product of a feature vector of a corresponding sample in the feature map and the weight vector. In some examples, the weight vector may have a dimension value of K, i.e., the weight vector may have K values, where K is the number of known labels for the one or more objects in the image.

In some embodiments, the system may further determine locations of one or more objects based on the values of corresponding samples of the object center heatmap. For example, a list of positions in the image may be selected as object centers by filtering out the positions whose values of corresponding samples in the object center heatmap are below a threshold value. In some embodiments, the system may apply a filter to the object center heatmap to generate a smoothed object center heatmap, and select the locations of the one or more objects using the smoothed object center heatmap. In some examples, the filter may be a Gaussian filter, such as an anisotropic Gaussian filter. The size of the Gaussian filter may be determined based on the size of the objects in the image. For example, for detecting textual character labels, the size of the Gaussian filter (e.g., width and height) may be determined based on the character size, which may be trained and stored in the system.

In some embodiments, the system may recognize the one or more objects in the image by processing the locations of the one or more objects in the image using a second machine learning model and the feature map. The second machine learning model may also be trained during a field training process. In recognizing an object, at each position from the locations of one or more objects, the system may generate an object feature vector. An object feature vector may be a representation of an object that depicts certain features of the object, such as the features extracted from the image using the pre-trained machine learning model. For example, the object feature vector may be generated using a portion of the feature map of the image, wherein the portion of the feature map is based on an area surrounding the location of the respective object. The second machine learning model may include a weight matrix comprising a plurality of weights in a matrix. The weights in the weight matrix may be trained. In some examples, the system may process the object feature vector using the second machine learning model to generate a class vector, and recognize the one or more objects by classifying each object to a label of the plurality of known labels using the class vector. A class vector may be a representation of known classes for one or more objects (e.g., characters, machine parts, or other objects). The class vector may include a plurality of values each corresponding to one of a plurality of known labels for the objects to detect.

In some aspects, the above described techniques may be applied to the problem of character detection (e.g., OCR). For example, a first machine learning model may be configured to extract certain features of the image that allow detecting characters locations in the image. A second machine learning model may be configured to extract certain other features of the image that allow the system to recognize the characters in the image. Each of the first and second machine learning models may include far fewer weights than a complex machine learning model, and thus, may be faster to train. Additionally, training these smaller machine learning models may not require a large training set, making it more feasible to train these models in the field.

In some embodiments, the system may use a pre-trained machine learning model to extract a feature map of the image for other processing steps. The feature map may be a representation of an image and contain certain features in the image. For example, the feature map may include a plurality of samples each including a vector having multiple values that encode semantic information at a corresponding position in the image. In some examples, the pre-trained machine learning model may be a deep machine learning model, e.g., a CNN or other neural network models. The pre-trained machine learning model may be trained using a large collection of training data off-line. Once trained, the pre-trained machine learning model will not need to be adjusted, making it feasible to be deployed in a field application. Using the pre-training machine learning model to generate a feature map of the image take advantages of the benefits of the deep machine model in its robustness and immunity to noise.

In some embodiments, the system may combine various types of machine learning models. For example, the inventors have appreciated that it can be desirable to use (1) a pre-trained machine learning model to extract certain semantic features in the image; and (2) other machine learning models to extract other features of the image, where the other machine learning modes can be trained quickly when deployed in the field. For example, the pre-trained machine learning model may be a deep machine learning model, e.g., a CNN or other neural network models. The other machine learning models may include the first machine learning model and the second machine learning model described above. In some embodiments, the system may use the first machine learning model and the feature map obtained from the pre-trained machine learning model to detect locations of the characters. Additionally, the system may use the second machine learning model and the feature map obtained from the pre-trained machine learning model to recognize the characters in the image. This combination of deep machine learning model(s) (e.g., which may be pre-trained, given the amount of time and/or computing power required to train such models) and other types of models that can be trained when deployed, thus, may gain the benefits of deep machine learning models in system performance and robustness, while offering the flexibility in adapting the system to a particular field application. This may overcome some or all of the drawbacks in the conventional systems as discussed above.

In some aspects, some variations of the embodiments described above may include systems, computerized methods, and non-transitory instructions, which may be provided to process an image containing one or more characters and detect the one or more characters. Detecting one or more characters may include an operation for detecting the locations of one or more characters. Additionally, detecting characters in an image may also include recognizing one or more characters to a respective known label (class). In some embodiments, the system may obtain an image containing one or more characters, and process the image using a pre-trained machine learning model to generate a feature map of the image. The pre-trained machine learning model may be a deep machine learning model, in some examples. The system may generate a character center heatmap by processing the feature map of the image using a first machine learning model. Similar to an object center heatmap, a character center heatmap may be a representation of an image that depicts the likelihood of one or more pixels in the image being a center of a character. For example, the character center heatmap may include a plurality of samples each having a value indicative of a likelihood of a corresponding sample in the image being a center of a character. In some examples, when the image contains textual characters, the value of each of the samples in the character center heatmap may be indicative of a likelihood of a corresponding sample in the image being a center of a textual character. Thus, the character center heatmap may represent a “character-center-ness” score for each corresponding position of a character in the image. For example, the value of a sample in the character center heatmap may be higher at a position proximate to the center of a character in the image, and may be lower at a position distal from the center of the character or in a region of the image that does not have characters. This may facilitate locating individual characters in an image.

In some examples, the system may determine the locations of one or more characters based on the values of corresponding samples of the character center heatmap. For example, by filtering out the positions whose values of corresponding samples in the character center heatmap are below a threshold value, a list of positions in the image may be selected as character centers. In some embodiments, the system may apply a filter to smooth the character center heatmap and select the locations of the one or more characters using the smoothed character center heatmap. In some examples, the filter may be a Gaussian filter, e.g., an anisotropic Gaussian filter. The size of the Gaussian filter may be determined based on the size of the character, e.g., the pre-stored character size, which can be trained and/or stored. The resulting list of positions obtained may include predicted centers of the characters in the image.

In some embodiments, the system may recognize one or more characters in the image by processing the locations of the characters in the image using a second machine learning model and the feature map. In recognizing a character, at each position from the locations of one or more characters, the system may generate a character feature vector. Similar to an object feature vector, a character feature vector may be a representation of a character that depicts certain features of the character, such as the features represented in the feature map of the image (obtained using the pre-trained machine learning model) that correspond to the character. For example, the character feature vector may be generated using a portion of the feature map of the image, wherein the portion of the feature map is based on an area surrounding the location of the respective character. The second machine learning model may include a weight matrix comprising a plurality of weights in a matrix. The weights in the weight matrix may be trained in the field. In some examples, the system may process the character feature vector using the second machine learning model to generate a class vector, and recognize the one or more characters by classifying each character to a label of the plurality of known labels using the class vector. A class vector may be a representation of known classes for one or more characters. For example, the class vector may include a plurality of values each corresponding to one of a plurality of known labels. In a non-limiting example, for industrial parts, the plurality of known labels may include the entire set of characters or symbols that are used in printed labels in the industrial parts.

In some embodiments, the systems described above may include applying the result of detecting objects (e.g., characters) in one or more applications. For example, the one or more objects in an image may include one or more printed textual characters on a machine part contained in the image. Thus, a system may be configured to recognize the one or more textual characters on the part and track the part using at least one recognized textual character. In some embodiments, a system may be implemented in a barcode scanner, of which an image capturing device may be configured to capture an image containing parts having the labels printed thereon. The system may be configured to process the captured image by detecting the location of the barcode and decoding the located barcode.

As described above, various embodiments use a first machine learning model and a second machine learning model. In some embodiments, described herein are various techniques, including systems, computerized methods, and non-transitory instructions, that train the first and/or the second machine learning models in a field training process. In some embodiments, a training process may include initial training process using an initial set of training data, and a retraining processing using an updated set of training data. In a retraining process, the updated set of training data may include a portion of the initial set of training data, and/or new training data that may be acquired by the user, for example, via a user interface.

A field training process may include a training process, in which a machine learning model being trained may adapt itself to the specific conditions associated with a particular field application at a specific customer site or production line. Examples of specific conditions include particular font of characters or printing process used, particular lighting conditions, or the particular background, particular types of images to be processed, such as images containing machine parts in an assembly line. The field training may also including different training data than the training data used in training a pre-trained machine learning model, with or without overlapping. A field training process may include, for example, the user adding custom symbols (labels) and providing training images containing the new symbols for training the machine learning model. Thus, the field training may enable the system to achieve an improved performance over an exclusively pre-configured system.

By way of example, a training system which may be used to train the first and second machine learning models in detecting objects will be described in detail. In some embodiments, a training system may train the first machine learning model to be used in detecting objects, where the first machine learning model may include a weight vector. The system may obtain a plurality of training images and training labels corresponding to objects in the training images. The training labels may include a list of ground truth objects positions, each associated with an object in a corresponding one of the plurality of training images to indicate where the object appears in the image.

In some embodiments, the training system may determine a plurality of training feature maps respectively using one of the plurality of training images and the pre-trained machine learning model, in a similar manner as a feature map is determined from an image previously described above in the system for detecting characters/objects. For example, the pre-trained machine may be a deep machine learning model. The system for training the machine learning models may further include determining ground truth object center heatmaps, and determining weights of the first machine learning model using the training feature maps and the ground truth object center heatmaps. In some embodiments, the value of each sample in the ground truth object center heatmap may be generated based on the distance to the nearest ground truth object position in the training image.

In some examples, for each object in the training images, the system may further determine a corresponding object feature vector using a portion of the training feature map of the corresponding training image. An object feature vector may be a representation of an object that depicts certain features of the object and may be obtained in a similar manner as previously described for detecting characters/objects.

In some examples, the system may obtain a location of an object from the ground truth object position in the training image; and determine the object feature vector using the portion of the feature map of the corresponding training image based on the location of the object. The operation of determining a portion of a feature map may be similar to that previously described in the system for detecting characters/objects. In determining the object feature vector, the system for training the machine learning models may use an aligning method to determine multiple sub-feature vectors each based on a respective position in the portion of the feature map, and concatenate the multiple sub-feature vectors to form the object feature vector.

Accordingly, for all training images, the system may have determined a plurality of object feature vectors and a plurality of ground truth object center heatmap values according to the techniques described above. In determining the weights in the first machine learning model, the system may use a suitable machine learning method such that the dot product between the first machine learning model (e.g., weight vector) and each object feature vector is as close as possible to the corresponding ground truth object center heatmap value. The method for training the weight vector may include linear regression, SVM, or other suitable machine learning methods.

In some examples, a training system may be provided to train the second machine learning model to be used in detecting objects (e.g., characters), where the second machine learning model may include a weight matrix. In some examples, the system may obtain a plurality of training images and training labels. Each of the plurality of training labels may be associated with a character in a corresponding one of the plurality of training images. For example, the training labels may include a list of ground truth character positions, each associated with a character in a corresponding one of the plurality of training images to indicate where the character appears in the image. The system may also include a ground truth character class list containing a list of classes that represent the identity of the character at each ground truth character position. In the case of textual characters, the character classes may correspond to textual characters, such as “A” to “Z” or other labels that may be used in the field application. In some examples, the system may obtain the character class list by using a label encoding method. For example, the system may collect all of the character classes that appear in the training labels and discard repeated ones to generate a list of distinct character classes.

Additionally, the system may determine the training feature maps using the pre-trained machine learning model in a similar manner as was previously described in training the first machine learning model. For example, the pre-trained machine may be a deep machine learning model. The system may further determine weights of the second machine learning model using the plurality of training feature maps and the plurality of training labels. In determining the weights of the second machine learning model, for each of the objects in the training images, the system may determine a corresponding object feature vector using a portion of the feature map of the corresponding training image in which the object is located, in a similar manner as previously described in training the first machine learning model.

Additionally, the system may also determine a target vector for each of the objects in the training images. A target vector may be a representation of an object (e.g., a character) that depicts an association of the object with one or more known classes. In some examples, the target vector may be determined using an encoding method. For example, a one-hot encoding method may be used. Accordingly, after determining the object feature vectors and the target vectors for each of the ground truth object positions in the training images, the system may determine the second machine learning model (e.g., the weight matrix) such that, when the second machine learning model (e.g., weight matrix) is multiplied with each object feature vector, the product reproduces the corresponding target vector as closely as possible. Similar to the training of the first machine learning, a machine learning method, such as linear regression, SVM, or other suitable machine learning methods may be used to train the weight matrix in the second machine learning model.

Although the techniques for training machine learning models are described using objects, such training techniques may also be applied to training machine learning models for types of objects (e.g., detecting characters). While some examples described herein are described in conjunction with OCR techniques, it should be appreciated that such examples are for illustrative purposes only and are not intended to be limiting, as the techniques are not limited to OCR applications.

The techniques described herein may provide advantages over conventional systems in improving the performance of object/character detection. By using a pre-trained deep neural network as feature extractor, the system can use higher-level semantic information for the object localization and classification. Compared to systems without using deep neural networks, the systems described herein are more robust and less affected by image noise, object appearance variation, variation in printing quality, differences in lighting and background, etc.

The techniques described herein may also provide advantages over conventional systems in further improving the performance of object/character detection by additionally using one or more other machine learning models that can be trained in a field training process. These machine learning models may be trained in a field training process and adapted to specific conditions that may occur in a field application. Thus, the system may enable a user to adapt the system with custom provided training images and/or updating labels. By training only a small portion of the system, simple machine learning methods, such as linear regression or other suitable methods, may be used to train the other machine learning models efficiently, without using expensive computational resources or large set of training images as with training a deep machine learning model.

Whereas various embodiments have been described, it will be apparent to those of ordinary skill in the art that many more embodiments and implementations are possible. Accordingly, the embodiments described herein are examples, not the only possible embodiments and implementations. Furthermore, the advantages described above are not necessarily the only advantages, and it is not necessarily expected that all of the described advantages will be achieved with every embodiment.

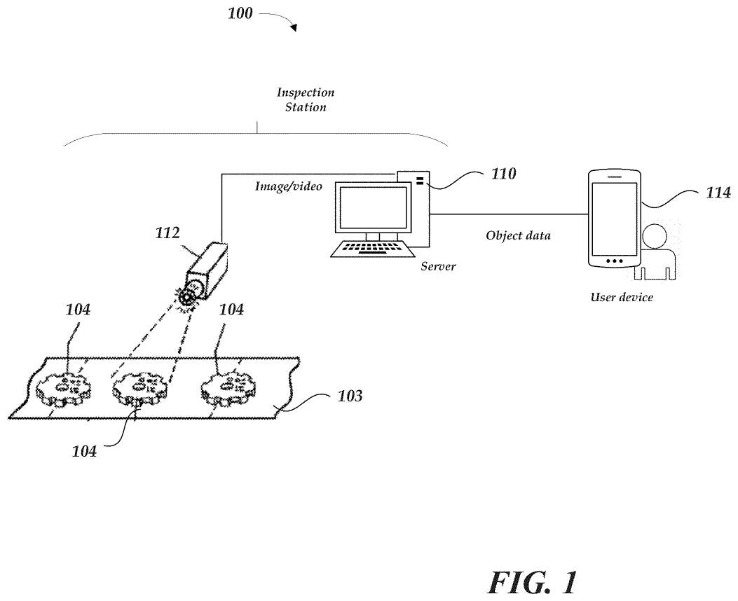

FIG. 1 is a diagram of a system for detecting objects, according to some embodiments of the technologies described herein.

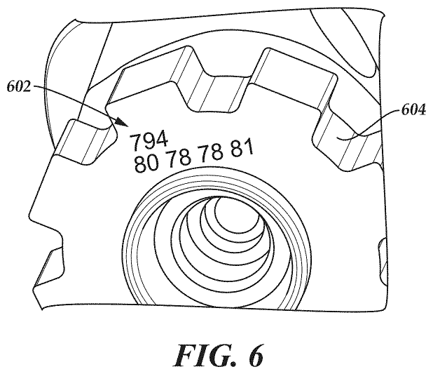

In some embodiments, a system 100 may include an image capturing device 112, such as a camera, which is configured to capture a video or an image of a part 104 or any component on an inspection platform 103. A captured video may include a sequence of frame images, and each image may contain one or more parts 104 on the inspection platform 103. The system 100 may further include a server 110 having at least a processor, a memory, a storage medium, and/or other components. The at least one processor may be configured to execute programming instructions stored in the memory to analyze the images and perform object detection on each of the images to detect one or more objects in the images. FIG. 6 is an example part including characters printed thereon that can be detected, according to some embodiments of the technologies described herein. In FIG. 6, one or more objects 602 may include textual character labels printed on a part 604. It is appreciated that an object in an image may not be limited to textual character labels.

Returning to FIG. 1, the server 110 may be configured to process a captured image of one or more parts in real-time during an inspection process. In a non-limiting configuration, the part 104 may be placed on the inspection platform 103. For example, the inspection platform 103 may be a conveyor belt of an assembly line or a turntable on which multiple parts to be inspected are placed. The inspection platform 103 may be controlled to move the parts. Each time the inspection platform 103 moves a part (e.g., part 104) into a location for inspection, the part on the inspection platform 103 is captured by the image capturing device 112 such that the system 100 may process the captured image to detect one or more objects (e.g., characters) on the part. When the detection is completed, the inspection platform 103 moves so that the next part is moved into position for inspection, and a new image containing the part that just moved into the position is captured, and the new image is processed to detect one or more objects in that image. This inspection process repeats for each of the parts to be inspected. The server 110 can be configured to process the captured image for each of the parts during an inspection process. While the example in FIG. 1 and FIG. 6 only show one part 104 per captured image, it should be appreciated that multiple parts can be contained in a captured image, which can be processed for detecting objects in each of the multiple parts, as desired.

System 100 may be configured to detect one or more objects in an image. In some embodiments, detecting the one or more objects may include determining locations of the one or more objects in the image using one or more machine learning models. For example, for an input image (e.g., an image captured by the image capturing device 112) of a part, the system 100 may be configured to process the input image using a pre-trained machine learning model to extract a feature map of the image. The pre-trained machine model may include a deep machine learning model that was previously trained and stored. For example, the feature map may include a plurality of samples each being a vector encoding semantic information at a corresponding position in the image.

In some embodiments, the system 100 may generate an object center heatmap from the feature map using a machine learning model (e.g., a first machine learning model). An object center heatmap may include a plurality of samples each having a value indicative of a likelihood of a corresponding pixel in the image being a center of an object. Thus, in an object center heatmap, a sample proximate to a center of an object may have a different value than that of another sample distal from the center of the object, where the difference of values among the samples in the object center heatmap may be used to discern samples proximate to centers of objects from samples that are distal from the centers of the objects in the image. Accordingly, server 110 may be configured to determine the center locations of the objects in the image based on the object center heatmap.

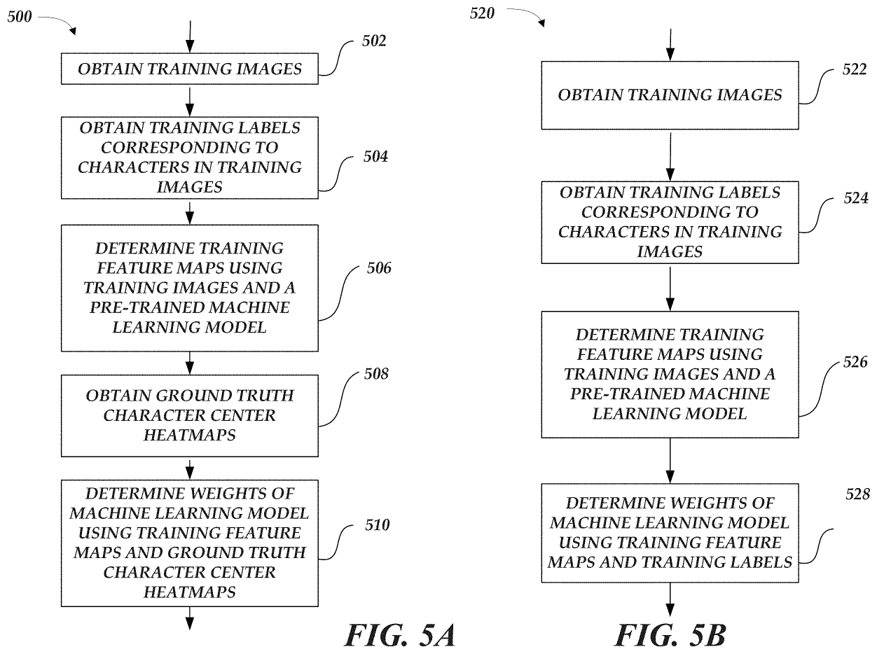

In some embodiments, detecting the one or more objects may further include recognizing the one or more objects in the image by processing the locations of the one or more objects in the image using another machine learning model (e.g., a second machine learning model) and the feature map obtained from the pre-trained machine learning model. In some examples, for each of the one or more located objects in the image, the system 100 may determine a portion of the feature map of the image corresponding to an area surrounding the location of the object. The system 100 may use the portion of the feature map to classify the object to a label of a plurality of known labels. A label may include a representation of an object in the image. For example, a label may be an ASCII representation for a textual character or any suitable value that may represent one of a plurality of classes. The plurality of known labels may vary depending on the application. For example, for detecting labels on a part, the plurality of known labels may be limited to textual characters. In that case, the known labels for a part may include both numerical numbers and alphabets, and the known labels may be converted to a character class list. Accordingly, the second machine learning model may be trained such that the second machine learning model may be configured to output a class of the plurality of known labels for one or more objects in an image. Generating the class list is further described in a field training process, such as 500 (in FIG. 5A).

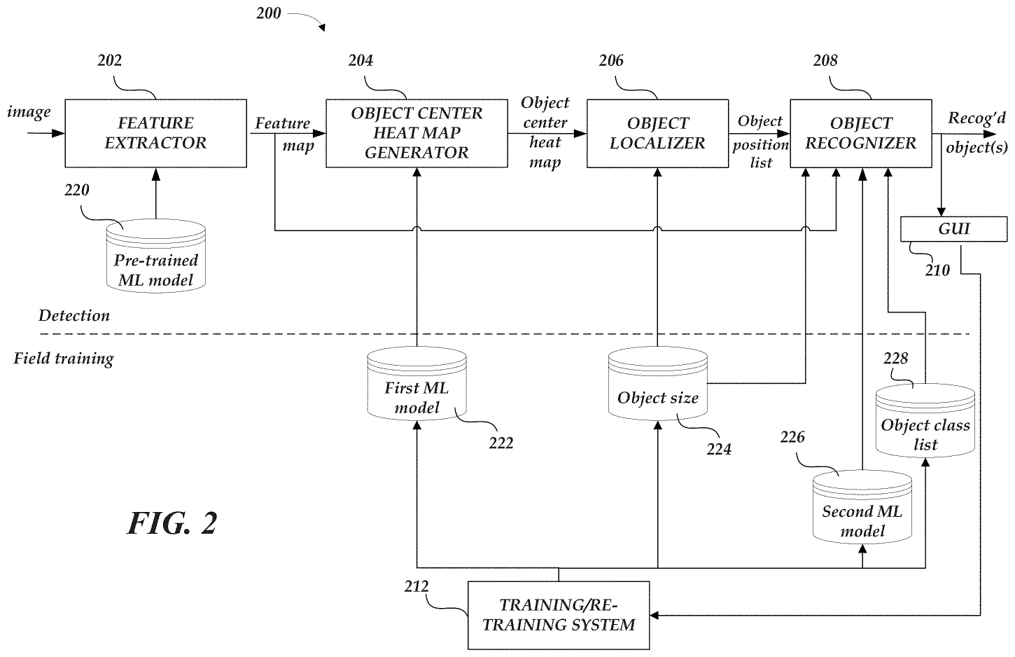

In some embodiments, the first machine learning model and the second machine learning model described above in system 100 may be different from the pre-trained machine learning model in that the pre-trained machine learning model is a deep machine learning mode, whereas the first and the second machine learning models are not deep machine learning models. For example, the first and the second machine learning models may each include a respective vector or matrix having multiple weights that can be trained fast. This may be particularly useful for deploying the system 100 in a domain where training a deep machine learning model (e.g., the pre-trained machine learning model) may be infeasible due to lack of computing resources and lack of training data at the user's site. Instead, the first and the second machine learning models may be trained in the field to extract certain features specific to the application. For example, in recognizing labels in certain parts, a set of training data set may be obtained by the user to train the first and the second machine learning models, where the training data set include training images containing the parts having labels thereon. Details of methods that may be implemented in system 100 for detecting objects in an image using one or more machine learning models and training the machine learning models are further described with reference to FIGS. 2-4 and 5A-5B.

With further reference to FIG. 1, once one or more objects in an image are detected, object data may be transmitted to a user device 114. In some embodiments, the object data may include locations of one or more objects on a part contained in the image. In other embodiments, the object data may include labels that are recognized from the one or more objects in the image, e.g., textual character labels on a part. The user device 114 may be configured to use the object data obtained from server 110 to perform various operations associated with the part in the image.

In a non-limiting example, the one or more objects in an image may include one or more printed textual characters on a part contained in the image. Thus, system 100 may be configured to recognize the one or more textual characters on the part and track the part using at least one recognized textual character. In some embodiments, system 100 may be implemented in a barcode scanner, of which an image capturing device (e.g., 112) may be configured to capture an image containing parts having the labels printed thereon. System 100 may be configured to process the captured image by detecting the location of the barcode and decode the located barcode. Various arrangement of components in system 100 may be configured to enable a particular application. For example, user device 114 may be configured to be a barcode (e.g., 1D or 2D) scanner. User device 114 may include an image capturing device 112 (e.g., a phone camera) to capture an image of a part having a barcode thereon. The user device may be configured as a barcode scanner to detect a location of a barcode (e.g., 1D or 2D barcode) in the captured image and decode the barcode in the image based on detected location of the barcode. Various other applications may also be implemented in system 100.

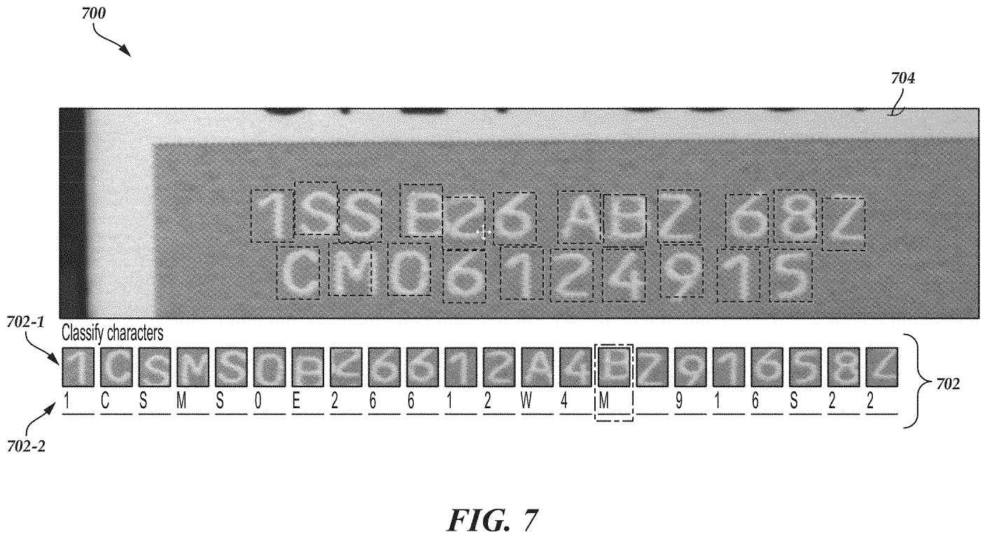

In some embodiments, user device 114 may be provided with a graphical user interface to display the object data. For example, the object data may include a recognized label on a part and the user device 114 may display the recognized label along with the image containing the part such that the user may determine whether the label is correctly recognized. In addition, the user device 114 may be configured to allow the user to make corrections if a label is incorrectly recognized. FIG. 7 shows an example graphical user interface for correcting labels in a training/re-training process, according to some embodiments of the technologies described herein. As shown in FIG. 7, graphical user interface 700, which may be implemented in the user device 114 (FIG. 1), may include a portion 702 that displays each of the objects (e.g., characters) in the image in a first area 702-1 and display the corresponding recognized labels in a second area 702-2. As shown, the characters in the first area 702-1 and the recognized labels in the second area 702-2 are aligned so that the user may determine whether the corresponding labels are correctly recognized. In some embodiments, user interface 700 may allow the user to make corrections to incorrectly recognized labels. For example, in area 702-2, recognized labels may be displayed in editable text box(es) which allow the user to modify the labels.

In some embodiments, the object data transmitted from server 110 (FIG. 1) to the user device (e.g., 114 of FIG. 1) may include locations of each of the characters along with the recognized labels. The user device may use the received location information about each of the characters to segment the character from the captured image and display them in the user interface 700, such as display area 702-1 of FIG. 7. Additionally, the user interface 700 may also include an area 704 configured to display a portion of the image that contains the characters.

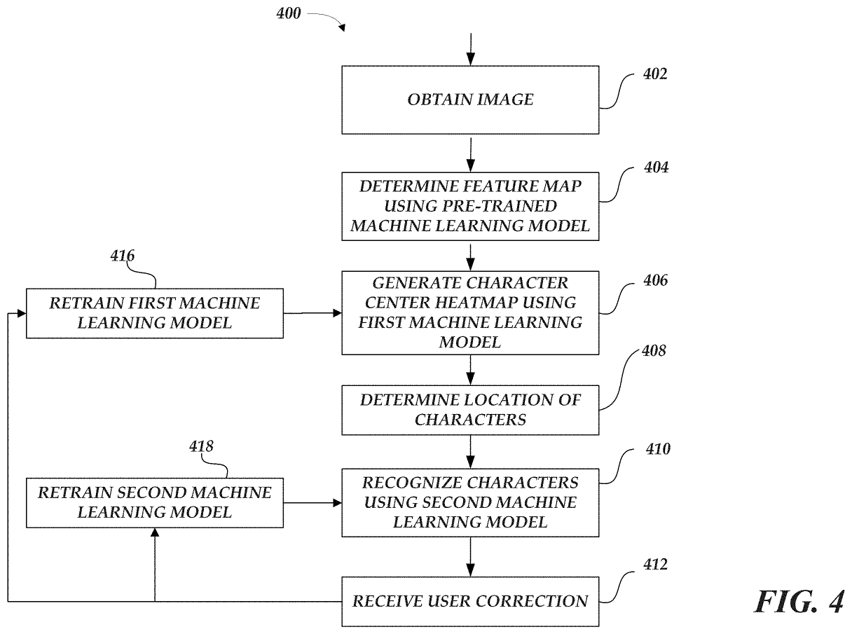

Returning to FIG. 1, in some embodiments, user device 114 may be configured to transmit any user-modified information, such as the modified labels entered by the user via graphical user interface 700 (FIG. 7), to server 110. This modified information may be used by server 110 to train one or more machine learning models used in the system 100. Details of training methods that may be implemented in system 100 for detecting objects in an image are further described in the present disclosure with reference to FIGS. 4 and 5A-5B.

In FIG. 1, although server 110 and user device 114 are shown to perform the object detection using machine learning models and train the machine learning models, it is appreciated that a single computing device (e.g., at the server or the user device) may be configured to perform the detecting/training operations. In other variations, the embodiments described herein may also be implemented in multiple computing devices in a distributed system.

FIG. 2 is a diagram of a system 200 for detecting objects using machine learning models and training the machine learning models, according to some embodiments of the technologies described herein. System 200 may include one or more blocks that may be implemented in the system 100 (FIG. 1). In some embodiments, system 200 may include one or more blocks configured to perform object detection from an image using machine learning models. System 200 may also include one or more blocks configured to perform training one or more machine learning models used in the detection operations. As shown in FIG. 2, system 200 may be configured to operate in detection mode and field training mode. For example, in the detection mode, the system 200 may use a pre-trained machine learning model 220 and other machine learning models (e.g., 222, 226) to perform one or more detection operations. Additionally, in the field training mode, the system 200 may be configured to train the other machine learning models (e.g., 222, 226) in one or more field training processes.

A pre-trained machine learning model may be a machine learning model that is trained at a time prior to the machine learning model being deployed and used at a site (e.g., in a customer application). The pre-trained machine learning model may be trained at a site different from where the machine learning model is deployed in the field application. In some embodiments, once deployed, the pre-trained machine learning model may not be modified. In some embodiments, some types of machine learning models (e.g., 222, 226) may be trained in a field training process. These machine learning models may be trained at a site different from where the pre-trained machine learning model is trained, at a time after when the pre-trained machine learning model is trained, and/or in a stage different than a stage in which the pre-trained machine learning model is trained. In a non-limiting example, the pre-trained machine learning model (e.g., 220) may be trained in a development/design stage prior to the system 200 being deployed. Other machine learning models (e.g., 222, 226) may be trained in a deployment stage while the system 200 is being deployed. For example, the deployment stage may include a field training mode, as previously described, in which the machine learning models may be trained in a field training process.

The pre-trained machine learning model 220 may be a deep machine learning model and trained at a site or location that is different from where the system 200 is deployed. In deploying system 200, the pre-trained machine learning model 220 may be used in combination with other machine learning models (e.g., 222, 226) that can be customarily trained by the user. For example, the user may collect application specific training data and use a training system 212 to train the other machine learning models (e.g., 222, 226). System 200 is now described further in detail.

In some embodiments of the techniques described herein, system 200 may include a feature extractor 202 configured to process an image and generate a feature map of the image using a pre-trained machine learning model 220. The image as input to the feature extractor may include an image captured in system 100 (e.g., via image capturing device 112 in FIG. 1). The pre-trained machine learning model may be a deep machine learning model that is trained to process an input image and output a feature map of the image. In some examples, the pre-trained machine learning model may be trained from a training dataset including a plurality of images containing one or more objects, e.g., labels including textual characters. The other machine learning models (e.g., 222, 226) may be trained using different training datasets, such as custom datasets that include images captured from applications in a particular domain, such as the image shown in FIG. 6.

In some embodiments, the feature map, as output of the pre-trained machine learning model may include a plurality of samples each including a vector (feature vector) having multiple values that encode semantic information at each respective position in the image. For example, the feature map may have a tensor of shape h×w×D, where h is the height of the feature map, w is the width of the feature map, and D is the number of channels of the feature map. The pre-trained machine learning model 220 may be configured to encode some features of the image for subsequent processing. In some examples, the pre-trained machine learning network may include a feature pyramid network and an upsampling-and-concatenation network. The feature pyramid network may be a neural network that takes an image as input and outputs one or more feature maps that are generated independently, for example, at different scales. In a non-limiting example, the feature pyramid network may generate multiple feature maps of different sizes, e.g., h1×w1×D1, h2×w2×D2, and h3×w3×D3. Various implementations of a feature pyramid network may be available. For example, feature pyramid networks as described in Lin et al., “Feature Pyramid Networks for Object Detection,” December, 2016, (arxiv.org/abs/1612.03144), may be used, and herein incorporated by reference in its entirety.

In some embodiments, the upsampling-and-concatenation network in the pre-trained machine learning network may be configured to take each feature map and upsample it (e.g., using a bi-linear interpolation) to a common size h×w. As such, the multiple feature maps may be respectively converted to feature maps of sizes: h×w×D1, h×w×D2, and h×w×D3. These feature maps may be concatenated to generate the output feature map of size h×w×D. In some examples, the number of channels D in the output feature map may have a value D=D1+D2+D3. In a non-limiting example, the feature map may have a different size than that of the image. For example, h and w may take the values of H/8 and W/8, respectively, or other suitable values, where H and W are the size of the image. The width and height of an image may not be equal, nor are the width and height of a feature map. For example, h may have a value of 16, and w may have a value of 24. Any other suitable values may be possible for h and w. In a non-limiting example, the number of channels D may have a value of 128, or other suitable values. When the pre-trained machine learning network is a deep CNN, the CNN may be configured to include a feature pyramid network by selecting some layers in the CNN and using their activations as output. Such pre-trained machine learning network may be deployed in an application in various domains without needing to be retrained.

With further reference to FIG. 2, system 200 may include an object center heat map generator 204 configured to generate an object center heatmap by processing the feature map of the image using a first machine learning model (e.g., 222 of FIG. 2). The object center heatmap may include a plurality of samples each having a value indicative of a likelihood of a corresponding sample in the image being a center of an object. In a non-limiting example, the first machine learning model (e.g., 222 in FIG. 2) may include a weight vector. The weight vector may have a dimension value of K, i.e., the weight vector may have K values, where K is the number of known labels for the one or more objects in the image. In some examples, each value in the weight vector may be a floating point number. It is appreciated that the values in the weight vector may also be integers. In some embodiments, a value of each sample in the object center heatmap may be a dot product of a feature vector of a corresponding sample in the feature map and the weight vector.

With continued reference to FIG. 2, system 200 may further include an object localizer 206 configured to determine locations of one or more objects in the image. In some embodiments, samples near a center of an object in an image may have higher values in the object center heatmap (provided by object center heatmap generator 204) than samples in other areas in the image. As such, object localizer 206 may determine the locations of the one or more objects in an image based on the values of corresponding samples of the object center heatmap. For example, a list of positions in the image may be selected as object centers by filtering out the positions whose values of corresponding samples in the object center heatmap are below a threshold value.

In some embodiments, object localizer 206 may perform a smoothing operation on the object center heatmap to generate a smoothed object center heatmap, and select the locations of the one or more objects using the smoothed object center heatmap. In a non-limiting example, a Gaussian filter, e.g., an anisotropic Gaussian filter may be used in the smoothing operation. In some embodiments, the size of the Gaussian filter may be determined based on the size of the objects in the image. For example, for detecting textual character labels, the size of the Gaussian filter (e.g., width and height) may be determined based on the object size 224, which may be trained and stored in the system 200.

In some embodiments, system 200 may include an object recognizer 208 configured to recognize one or more objects in the image by processing the locations of the one or more objects in the image (determined by object localizer 206) using a second machine learning model (e.g., 226 of FIG. 2) and the feature map, where the second machine learning model 226 may include a weight matrix. In recognizing an object, object recognizer 208 may, at each position from the list of positions of one or more objects, generate an object feature vector using a portion of the feature map of the image, wherein the portion of the feature map is based on an area surrounding the location of the respective object. Object recognizer 208 may process the object feature vector using the second machine learning model 226 to generate a class vector, wherein the class vector includes a plurality of values each corresponding to one of a plurality of known labels. Thus, object recognizer 208 may classify an object to a label of the plurality of known labels using the class vector.

With further reference to FIG. 2, system 200 may include a training system 212 configured to train the various machine learning models used in the detection process, such as the first machine learning model 222 and the second machine learning model 226. The first and the second machine learning models 222, 226 each may be a non-deep machine learning model, and can be trained efficiently in the training system in a field training process. System 200 may further include a graphical user interface 210, which may be configured to provide a user interface tool to allow the user to make modifications to the detection result from object center heatmap generator 204 or object recognizer 208. The user modifications received in the user interface 210 may be provided to the training system 212. Methods for training the first and the second machine learning models are described in detail with reference to FIGS. 5A and 5B.

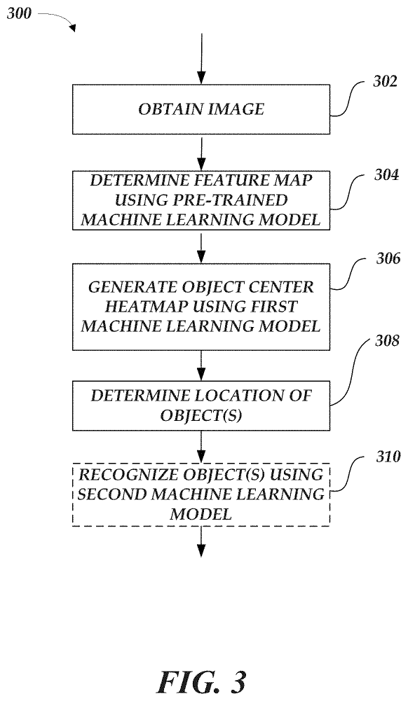

FIG. 3 is a flow chart showing an exemplary computerized method 300 for detecting objects, according to some embodiments of the technologies described herein. Method 300 may be implemented in systems 100 (FIG. 1) or 200 (FIG. 2), for example. In some techniques described herein, method 300 may begin with act 302 to obtain an image. The image may include an image captured in a system (e.g., via image capturing device 112 of system 100 in FIG. 1). Method 300 may proceed at act 304 to determine a feature map of the image using a pre-trained machine learning model. Act 304 may be implemented in a feature extractor, e.g., 202 (FIG. 2). In a non-limiting example, the feature extractor may use a pre-trained machine learning model, e.g., a deep CNN, with an input layer having a size (e.g., height, weight, channel). For example, the input image as input to the pre-trained machine learning model may have a size of H×W×C, where H is the height of the image, W is the width of the image, and C is the number of channels of the image. It is appreciated that the number of channels may be any suitable number. For example, C may have a value of 3 in a RGB color image, whereas C may have a value of 1 in a grayscale image.

In some embodiments, the feature map, as output of the pre-trained machine learning model may have a tensor of shape h×w×D, where h is the height of the feature map, w is the width of the feature map, and D is the number of channels of the feature map. In other words, each sample in the h x w grid of the feature map may be associated with a respective vector (feature vector). Examples of the pre-trained machine learning model are described previously in FIG. 2 with reference to pre-trained machine learning model 220. As described above, the feature map may include a plurality of samples each including a vector encoding semantic information at each respective position in the image.

With further reference to FIG. 3, method 300 may include generating an object center heatmap at act 306. In some examples, act 306 may be implemented in an object center heat map generator (e.g., 204 of FIG. 2). Act 306 may process the feature map of the image using a first machine learning model (e.g., 222 of FIG. 2) to generate the object center heatmap for the image, where the first machine learning model may be trained in a field training process. The object center heatmap may include a plurality of samples each having a value indicative of a likelihood of a corresponding sample in the image being a center of an object. The size of an object center heatmap may be the same as that of the feature map, e.g., h×w. For a sample in the object center heatmap, the corresponding sample in the image may be a pixel in the grid H×W. In the above example, where h=H/8, w=W/8, for a sample (x, y) in the object center heatmap, the corresponding sample in the image is the pixel at location (x*8, y*8). In some examples, when the image contains textual characters, the value of each of the samples in the object center heatmap may be indicative of a likelihood of a corresponding sample in the image being a center of a character.

In a non-limiting example, the first machine learning model (e.g., 222 in FIG. 2) may include a weight vector. In the example described above, the feature map may have h×w samples arranged in an array corresponding to the pixel arrays in the image, where each sample is represented by a D-dimensional vector. The object center heatmap may also include a plurality of samples arranged in a similar manner as the samples in the feature map are arranged, such that a sample in the object center heatmap may correspond one-one-one to a sample in the feature map, which may correspond to a pixel in the image. In some embodiments, a value of each sample in the object center heatmap may be a dot product of a feature vector of a corresponding sample in the feature map and the weight vector.

In some embodiments, the weight vector may have a dimension value of K, i.e., the weight vector may have K values, where K is the number of known labels for the one or more objects in the image. The weight vector may be trained such that the values in the object center heatmap may be indicative of a likelihood of a corresponding sample in the image being a center of an object. In some examples, each value in the weight vector may be a floating point number. It is appreciated that the values in the weight vector may also be integers. The training process for training the weight vector is further described with reference to FIG. 5A.

With continued reference to FIG. 3, method 300 may further include determining locations of one or more objects at act 308. In some embodiments, act 308 may be implemented in an object localizer (e.g., 206 in FIG. 2) in system 200. As described previously, samples near a center of an object in an image may have higher values in the object center heatmap than samples in other areas in the image. As such, act 308 may determine the locations of the one or more objects in an image based on the values of corresponding samples of the object center heatmap. For example, a list of positions in the image may be selected as object centers by filtering out the positions whose values of corresponding samples in the object center heatmap are below a threshold value.

In some embodiments, act 308 may perform a smoothing operation on the object center heatmap to generate a smoothed object center heatmap, and select the locations of the one or more objects using the smoothed object center heatmap. In some examples, act 308 may perform the smoothing operation using a smoothing filter, such as a Gaussian filter. A Gaussian filter may be anisotropic. The size of the Gaussian filter may be determined based on the size of the objects in the image. For example, for detecting textual character labels, the size of the Gaussian filter (e.g., width and height) may be determined based on the character size. In some examples, the object size may be trained and stored (e.g., at 224 of FIG. 2) for subsequent use. As described above, the resulting list of positions obtained in act 308 may include predicted centers of the objects in the image. In some examples, if a corresponding position of a sample in the object center heatmap is not on the grid of the image (e.g., H×W), interpolation may be used to determine a position on the grid.

In some embodiments, method 300 may optionally include recognizing the one or more objects in the image at act 310. Act 310 may be implemented in an object recognizer (e.g., 208 of FIG. 2), in some embodiments. Act 310 may process the locations of the one or more objects in the image using a second machine learning model (e.g., 226 of FIG. 2) and the feature map to recognize the one or more objects. The second machine learning model may also be trained during a field training process. In recognizing an object, act 310 may, at each position from the list of positions of one or more objects, generate an object feature vector using a portion of the feature map of the image, wherein the portion of the feature map is based on an area surrounding the location of the respective object. Act 310 may process the object feature vector using the second machine learning model to generate a class vector, where the class vector includes a plurality of values each corresponding to one of a plurality of known labels. Thus, act 310 may classify an object to a label of the plurality of known labels using the class vector.

In some embodiments, act 310 may use an aligning method to extract a feature tensor from a portion of the feature map. For example, act 310 may define an area around each of the list of positions (predicted position of one or more objects) obtained in act 308. The size of the area around a position may be equal to a pre-stored object size (e.g., object size 224 in FIG. 2). In some embodiments, the area for each object may be represented in a bounding box. The system may use an aligning method to extract a feature tensor from a portion of the feature map of the image using the bounding box. For example, the system may extract the feature tensor by sampling the feature map at each of the positions within the bounding box. An example of an aligning method that may be used, such as RoIAlign method, is described in He et al., “Mask R-CNN” (arxiv.org/abs/1703.06870), and is herein incorporated by reference in its entirety. In a non-limiting example, the above described aligning method, such as RoIAlign, may extract a feature tensor from a portion of the feature map. For example, the extracted feature tensor may be a tensor having a size of 3×3×D, where D is the number of channels in the feature map. Other sizes, such as 4×4, 5×5, 8×8, or any other suitable size may also be possible.

Accordingly, act 310 may determine the object feature vector for each object by converting the extracted feature tensor into a one-dimensional vector. In the example above, where the feature tensor is of size 3×3×D, act 310 may determine the object feature vector by concatenating the individual vectors obtained from the aligning method (e.g., RoIAlign method described above) into a one-dimensional vector having all of the values of the portion of the feature map arranged in one dimension. In this case, the object feature vector has f×D values, where f=9 and D is the number of channels in the feature map.

In some embodiments, the plurality of known labels used for recognizing characters in an image may include the characters that might appear in a label. For example, for English labels, the number of known labels may be 26 for English capital letters “A” through “Z.” The second machine learning model (e.g., 226 of FIG. 2) may include a weight matrix. For example, the size of the weight matrix may be K×(f*D), where D is the number of channels of the feature map, K is the number of known labels (e.g., 26 in case of English capital letters), and f is a factor depending on the specific method of feature vector pooling. In the above example, f=3×3 =9.

In some embodiments, the system may determine a class score vector for each object by multiplying the weight matrix (of shape K×(f*D) by the object feature vector (of size f*D) , resulting in the class score vector having the size of K, where K is the number of known labels. Accordingly, each value in the class score vector corresponds to a predicted score for one of a plurality of known classes, such as known labels. In some examples, the system may select a maximum value among the plurality of values in the class vector, wherein the selected value corresponds to the label to be recognized. In the example described above, the known labels for object detection may include a plurality of textual characters. In some embodiments, the known labels may also include a class for non-text, which may be referred to as a background label. In some embodiments, the weight matrix may be trained such that the resulting values in the object class vectors may be indicative of a likelihood of the object being a corresponding known label. The training process for training the weight matrix is further described with reference to FIG. 5A.

Act 310 may be repeated for each of the positions in the list of positions determined from act 308, where each position in the list may correspond to a potential object (or character in the above example). Once act 310 is completed, the system may output a list of predicted characters at respective positions obtained from act 308, where the predicted character may be one of the known labels including a background label (e.g., non-textual). In such case, if a predicted character is a background label, it means that that the object being recognized is a non-textual or unknown label.

As described above with reference to method 300, the first machine learning model may include a weight vector, and the second machine learning model may include a weight matrix. These machine learning models may be trained by a respective machine learning method, such as a linear regression method, support vector machine (SVM), gradient boot decision trees, or other suitable methods. Because the first and the second machine learning models are not deep machine learning models, the training can be fast, making them suitable for field training in deploying the system. The training processes for training the first and the second machine learning models are further described in detail with reference to FIGS. 5A and 5B.

FIG. 4 is a flow chart of an illustrative process 400 for detecting characters using machine learning models and training the machine learning models, according to some embodiments of the technologies described herein. In some examples, method 400 may be implemented in system 100 (of FIG. 1), or system 200 (of FIG. 2). Method 400 may be similar to method 300 (of FIG. 3) except method 400 is provided to recognize one or more characters in an image. In various embodiments described herein, method 400 may include obtaining an image at act 402. Similar to act 302, the image may include a captured image from system 100 (FIG. 1), such as from an image capturing device 112. Method 400 may proceed with processing the image using a pre-trained machine learning model to generate a feature map of the image at act 404. In some examples, act 404 may be implemented in a feature extractor (e.g., 202 of FIG. 2). Similar to act 304, the pre-trained machine learning model may be a deep machine learning model (e.g., 220 in FIG. 2). An example of deep machine learning model may include a CNN having multiple layers. The configuration of the pre-trained machine learning model, as described with reference to FIG. 3, may also be used in method 400. The feature map obtained from act 404 may include a plurality of samples each including a vector having multiple values that encode semantic information about the image at a corresponding position.

With further reference to FIG. 4, method 400 may include generating character center heatmap at act 406. In some examples, act 406 may be implemented in object center heat map generator (204 of FIG. 2). Act 406 may process the feature map of the image using a first machine learning model (e.g., 222 of FIG. 2) to generate the character center heatmap for the image. The character center heatmap may include a plurality of samples each having a value indicative of a likelihood of a corresponding sample in the image being a center of a character. In some examples, when the image contains textual characters, the value of each of the samples in the character center heatmap may be indicative of a likelihood of a corresponding sample in the image being a center of a textual character. As in method 300, a sample in the h×w grid of a character center heatmap may correspond to a pixel in the H×W grid of the image.

As described above, the character center heatmap may represent a “character-center-ness” score for each corresponding position of a character in the image. For example, the value of a sample in the character center heatmap may be high at positions near the center of a character in the image, and may be low at positions distal from the center of the character or in the regions of the image that do not have characters. This facilitates locating of individual characters in an image, which may be further explained. With continued reference to FIG. 4, method 400 may further include determining locations of one or more characters at act 408. In some embodiments, act 408 may be implemented in an object localizer (e.g., 206 in FIG. 2) in system 200. As described previously, samples near a center of a character in an image may have higher values in the character center heatmap than those of samples in other areas in the image. As such, act 408 may determine the locations of the one or more characters in an image based on the values of corresponding samples of the character center heatmap. For example, by filtering out the positions whose values of corresponding samples in the character center heatmap are below a threshold value, a list of positions in the image may be selected as character centers.

In some embodiments, act 408 may include performing a smoothing operation on the character center heatmap in a similar manner as in act 308. For example, act 408 may generate a smoothed character center heatmap by applying a smoothing filter to the character center heatmap, and select the locations of the one or more characters using the smoothed character center heatmap. The smoothing filter may be a Gaussian filter, e.g., an anisotropic Gaussian filter. The size of the Gaussian filter may be determined based on the size of the character, e.g., the pre-stored character size (e.g., 224 of FIG. 2), which can be trained. The resulting list of positions obtained in act 408 may include predicted centers of the characters in the image. The character size may be any suitable size. For example, the character size may be 60 pixels by 40 pixels in an original input image (as obtained from act 402). If, by way of example, the feature map size is related to the image size (e.g., h=H/8 and w=W/8), then the character size will be 60/8 by 40/8 in units of feature vector samples. The size of the Gaussian filter is then determined as a fixed multiple of the character size.

In some embodiments, method 400 may include recognizing the one or more characters in the image at act 410. Act 410 may be implemented in the object recognizer (208 of FIG. 2), in some embodiments, and may be implemented in a similar manner as described in act 310. For example, act 410 may process the locations of the one or more characters in the image using a second machine learning model (e.g., 226 of FIG. 2) and the feature map to recognize the one or more characters from known labels stored in a character class list (e.g., object class list 228 in FIG. 2). Similar to the second machine learning model in method 300, the second machine learning model may also be trained during the field training process.

Similar to act 310, the output of act 410 may include a list of predicted characters at respective locations obtained from act 408, where the predicted character may be one of the known labels. In some embodiments, the known labels may also include a background label (e.g., non-textual). Similar to method 300, the first machine learning model used in method 400 may include a weight vector, and the second machine learning model used in method 400 may include a weight matrix. As can be appreciated, the first and the second machine learning models used in acts 406, 408 respectively are not a deep machine learning model, thus, can be efficiently trained in a field training process. For example, these machine learning models may be trained by a respective machine learning method, such as a linear regression method, a support vector machine (SVM), a gradient boot decision trees method, or other suitable methods. The training processes for training the first and the second machine learning models are further described in detail with reference to FIGS. 5A and 5B.

With further reference to FIG. 4, method 400 may further include receiving user modification at 412, via a user interface. The user interface may be implemented in GUI (e.g., 210 of FIG. 2) or any device in system 100 (e.g., server 110 or user device 114 of FIG. 1). In some examples, the system may display the recognition result from act 410 in the user interface, such as the example shown in FIG. 7 (see portion 702). The system may, via the user interface, receive a user modification. The user modification may include an updated (e.g., corrected) label or a new label. Thus, new training data that includes a new one-to-one mapping between a character in the image and one of known labels may be created. In some examples, for a character in an image, the user may provide a new label that did not exist in the known labels. In such case, new training data that includes a new one-to-one mapping between a character in the image and the new label may be created. The new label may also be stored in a character class list, e.g., object class list 228 in FIG. 2. In some examples, the character size may be updated based on new training data. For example, the character size may be an average of character size of all of the characters in the training images. As new training image is generated, the character size is updated and stored in the character size database, e.g., 224 in FIG. 2. The new training data may subsequently be used for training the first and the second machine learning models (e.g., 222, 226 in FIG. 2) for the new label. In some embodiments, method 400 may use the new training label to retrain the first machine learning model at act 416 or to retrain the second machine learning model at act 418. The training process for training the first and the second machine learning models are further described in FIGS. 5A and 5B.

Training methods for training the machine learning models in various embodiments described in the present disclosure, e.g., system 100 (FIG. 1), system 200 (FIG. 2), training system (212 of FIG. 2), method of retraining the first machine learning model (416 of FIG. 4) or the second machine learning model (418 of FIG. 4), are further described herein. These methods may be implemented in a field training process.

In some examples, in a field training process, the user may provide or supplement training data that include training images and corresponding training labels, where the training images may each contain the objects already known. The training labels may include ground-truth data for each of the training images, where the ground-truth data may include, for example, the labels of objects appearing in the image, the position(s) of each object appearing in the image, and the sizes of the objects. In some examples, these information may be provided by the user via a user interface, such as user interface 700 shown in FIG. 7.

Methods for providing the training data and training the machine learning models in a field training process are further described with examples of character labels. In a non-limiting example, the training system may include a user interface (e.g., 700 in FIG. 7) configured to display each of the training images in a display area (e.g., 704) and receive a user selection of a position (e.g., an annotation) for each of the characters that appear in the image. The user interface may further receive user input which may include a character location and label correspondence to indicate what each character in the image should be recognized. In some examples, the field training data may be generated in a batch process. In other examples, the field training data may be incrementally updated while the user is performing a recognition operation (e.g., 300 of FIG. 3 or 400 of FIG. 4), in which process the user may enter a correction for an incorrectly recognized character in the image.

FIG. 5A is a flow chart of an illustrative process 500 for training a machine learning model, according to some embodiments of the technologies described herein. In some embodiments, method 500 may train a first machine learning model (e.g., 222 in FIG. 2) to be used in detecting characters and may be implemented in system 100 (FIG. 1), system 200 (FIG. 2) such as training system (e.g., 212 of FIG. 2), or act of retraining the first machine learning model (e.g., 416 of FIG. 4). Method 500 may include obtaining a plurality of training images at act 502 and obtaining training labels corresponding to characters in the training images at act 504. By way of example, in a system for detecting characters in an image, the training labels may include a list of ground truth character positions, each associated with a character in a corresponding one of the plurality of training images to indicate where the character appears in the image.

Method 500 may further include determining a plurality of training feature maps respectively using one of the plurality of training images and a pre-trained machine learning model at act 506. For example, a training feature maps may be determined by using a corresponding training image and the pre-trained machine learning model (e.g., 220 in FIG. 2). This operation may be performed in a similar manner as in the detection process described in act 404 (FIG. 4), 304 (FIG. 3), or methods that are implemented in feature extractor 202.

Method 500 may further include determining ground truth character center heatmaps at act 508, and determining weights of the first machine learning model using the training feature maps and the ground truth character center heatmaps at act 510. The individual values of the samples in the ground truth character center heatmaps may be referred to as ground truth character-center-ness values. The ground truth character center heatmaps may be generated based on the distance to the nearest ground truth character position in the training label. For example, the ground truth character center heatmap include samples having high values at positions close to the centers of the ground truth character positions in the training labels, and having low values at positions far away from the ground truth character positions in the training labels. In an example implementation, the ground truth character center heatmap values may be computed as a Gaussian function applied to the distance to the nearest ground truth character position in the training labels. The standard deviation, or width, of the Gaussian functions may be calculated as a fixed multiple of the ground truth character size, in some examples.

In some embodiments, when multiple ground truth characters in the training labels are relatively close to each other, the ground truth character center heatmap values may instead be computed as the difference between two Gaussian functions applied to the distances to the two nearest ground truth character positions. In some examples, the ground truth character center heatmaps may have the same size as the training feature maps. Various methods for using the Gaussian function to generate character-center-ness values may be used. For example, a method that may be used is described in Baek et al., “Character Region Awareness for Text Detection,” 3 Apr. 2019, arxiv.org/abs/1904.01941, and is hereby incorporated by reference in its entirety.

In some embodiments, for each character in the training images, act 510 may further determine a corresponding character feature vector using a portion of the feature map of the corresponding training image. For example, method 500 may obtain a location of a character from the ground truth character positions in the training label associated with the corresponding training image in which the character is located; and determine the character feature vector using the portion of the feature map of the corresponding training image based on the location of the character. The operation of determining a portion of a feature map may be similar to the methods described in the detection process, such as methods implemented in the recognizer 208 (of FIG. 2), act 310 (FIG. 3), or act 410 (FIG. 4). For example, the character feature vector may be determined based on the ground truth character position, the character size (stored in 224 of FIG. 2, for example), and the feature map determined from the training images obtained from act 506.

The methods for determining the portion of the feature map corresponding to each of the characters in the image are implemented in a similar manner as those described in the detection process, such as acts 310, 410 (of FIG. 3, FIG. 4, respectively). In some examples, the portion of the feature map may be represented by a bounding box centered about the location of the training label in the corresponding training image. The corresponding character feature vector for each located character may be determined by concatenating multiple sub-feature vectors each formed based on a respective position in the portion of the feature map.

According to the above embodiments, for all of the training images, the system has determined a total of N character feature vectors and N ground truth character center heatmap values (character-center-ness values), where N is total number of grid cells in the training feature maps (e.g., the sum of h×w across all training images, where h, w are the size of each training feature map). In some embodiments, the first machine learning model (e.g., 222 in FIG. 2) may include values of a weight vector. The goal of the training is to find a weight vector wt such that its dot product with each ground truth character feature vector v is as close as possible to the corresponding ground truth character center heatmap value c such that wt·v≈c. In some embodiments, finding the weights in the weight vector may use any suitable machine learning method, such as a linear regression, SVM, or other suitable machine learning methods.

FIG. 5B is a flow chart of an illustrative process for training another machine learning model, according to some embodiments of the technologies described herein. In some embodiments of the technologies described in, training method 520 may train the second machine learning model (e.g., 226 in FIG. 2), and may be implemented in system 100 (FIG. 1), system 200 (FIG. 2) such as training system (e.g., 212 of FIG. 2), or act for retraining the second machine learning model (e.g., 418 of FIG. 4).

Method 520 may include obtaining a plurality of training images at act 522 and obtaining a plurality of training labels at act 524, in a similar manner as acts 502, 504 of method 500 (of FIG. 5A). Each of the plurality of training labels may be associated with a character in a corresponding one of the plurality of training images. For example, the training labels may include a list of ground truth character positions, each associated with a character in a corresponding one of the plurality of training images to indicate where the character appears in the image. The training labels may also include a ground truth character class list containing a list of character classes that represent the identity of the character at each ground truth character position. In the example above for textual characters, the character classes may correspond to textual characters, such as “A” to “Z” or other labels that may be specific for the domain in which the system is deployed. In some examples, the character size for all characters may be assumed to be about the same. In such case, the character size that is stored in database (e.g., 222 of FIG. 2) may include two values for width and height. It is appreciated that other suitable representation of character size may also be possible.

In some embodiments, the system may obtain the character class list by using a label encoding method. For example, the system may collect all of the character classes that appear in the training labels and discard repeated ones to generate a list of distinct character classes. The system may sort these distinct character classes in order. In some examples, the system may sort the distinct character classes in an arbitrary order to obtain the character class list. In some other examples, the system may sort the distinct character classes in other suitable order, such as an alphabetical order for English letters. Once the character class list is generated, it may be stored in the system (e.g., 228 in FIG. 2).

Method 520 may further include determining the training feature maps at act 526, which may be performed in a similar manner as act 506 of FIG. 5A. For example, the training feature maps may be determined using the pre-trained machine learning model having the plurality of training images as input, where the pre-trained machine (e.g., 220 in FIG. 2) may be a deep machine learning model, such as a CNN having multiple hidden layers. This operation may be performed in a similar manner as in a detection process described in act 404 (FIG. 4), 304 (FIG. 3), or methods that are implemented in feature extractor 202.

Method 520 may further determine weights of the second machine learning model using the plurality of training feature maps and the plurality of training labels at act 528. In some examples, the second machine learning model may be a weight matrix, where the size of the matrix is K×(f*D), where D is the number of channels of the feature map, K is the number of known labels (e.g., 26 in case of English capital letters), and f is a factor depending on the specific method of feature vector pooling, as explained above in the detection process described in the present disclosure. Thus, each row of the weight matrix corresponds to one of a plurality of known classes corresponding to the known labels.

In some examples, in determining the weights of the second machine learning model, method 520 may, for each of the characters in the training images, determine a corresponding character feature vector using a portion of the feature map of the corresponding training image in which the character is located, in a similar manner as character feature vector is determined in method 500 (e.g., act 510). Method 520 may also determine a target vector for each of the characters. In some embodiments, the target vector may be determined using an encoding method. For example, each labeled character in the training labels may be associated with a one-hot target vector of length K, where K is the number of distinct character classes. In some embodiments, a one-hot encoding method may be used. For example, if the character class list is [“A”, “B”, “C”, “D”], and a particular labeled character is of class “C”, then the one-hot target vector is the vector (0, 0, 1, 0). Other encoding methods may be used.

Accordingly, after determining the character feature vectors and the target vectors for each of the ground truth character positions in the training images, the training process 520 may determine the second machine learning model (e.g., the weight matrix) such that, when the weight matrix is multiplied with each character feature vector, the product reproduces the result as closely as possible to the corresponding target vector. Similar to the training of weight vector in method 500, a machine learning method, such as a linear regression, SVM, or other suitable machine learning methods may be used to train the weight matrix in the second machine learning model.

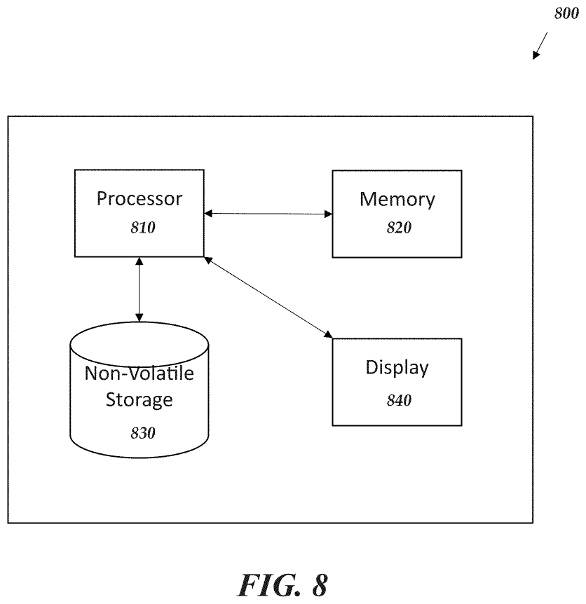

An illustrative implementation of a computer system 800 that may be used to perform any of the aspects of the techniques and embodiments disclosed herein is shown in FIG. 8. For example, the computer system 800 may be installed in system 100 of FIG. 1, such as by server 110. The computer system 800 may be configured to perform various methods and acts as described with respect to FIGS. 1-7. The computer system 800 may include one or more processors 810 and one or more non-transitory computer-readable storage media (e.g., memory 820 and one or more non-volatile storage media 830) and a display 840. The processor 810 may control writing data to and reading data from the memory 820 and the non-volatile storage device 830 in any suitable manner, as the aspects of the invention described herein are not limited in this respect. To perform functionality and/or techniques described herein, the processor 810 may execute one or more instructions stored in one or more computer-readable storage media (e.g., the memory 820, storage media, etc.), which may serve as non-transitory computer-readable storage media storing instructions for execution by the processor 810.

In connection with techniques described herein, code used to, for example, detect objects in images/videos may be stored on one or more computer-readable storage media of computer system 800. Processor 810 may execute any such code to provide any techniques for detecting objects as described herein. Any other software, programs or instructions described herein may also be stored and executed by computer system 800. It will be appreciated that computer code may be applied to any aspects of methods and techniques described herein. For example, computer code may be applied to interact with an operating system to detect objects through conventional operating system processes.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above.

The terms “program,” “software,” and/or “application” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion among different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. Data structures may have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Various inventive concepts may be embodied as one or more methods, of which examples have been provided. The acts performed as part of a method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This allows elements to optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

1. A computerized method for detecting one or more objects in an image, the method comprising:
determining a feature map of the image;
processing the feature map of the image using a first machine learning model to generate an object center heatmap for the image, wherein the object center heatmap comprises a plurality of samples each having a value indicative of a likelihood of a corresponding sample in the image being a center of an object; and
determining locations of one or more objects in the image based on the object center heatmap.

2. The method of claim 1, further comprising:
processing the locations of the one or more objects in the image using a second machine learning model and the feature map to recognize an object of the one or more objects.

3. The method of claim 2, wherein recognizing the object of the one or more objects comprises:
generating an object feature vector using a portion of the feature map of the image, wherein the portion of the feature map is based on an area surrounding the location of the object;
processing the object feature vector using the second machine learning model to generate a class vector, wherein the class vector comprises a plurality of values each corresponding to one of a plurality of known labels; and
classifying the object to a label of the plurality of known labels using the class vector.

4. The method of claim 3, wherein:
each value of the class vector is indicative of a predicted score associated with a corresponding one of the plurality of known labels; and
classifying the object comprises selecting a maximum value among the plurality of values in the class vector, wherein the selected value corresponds to the label.

5. The method of claim 3, wherein the plurality of known labels comprises a plurality of textual character labels.

6. The method of claim 3, wherein the plurality of known labels further comprises a background label.

7. The method of claim 2, further comprising training each of the first machine learning model and the second machine learning model using a respective machine learning method and using a respective set of field training data.

8. The method of claim 2, wherein:
the one or more objects comprise one or more printed textual characters on a part contained in the image; and
the method further comprises tracking the part using at least one textual character recognized from the one or more textual characters.

9. The method of claim 1, wherein determining the locations of the one or more objects comprises:
smoothing the object center heatmap to generate a smoothed object center heatmap; and
selecting the locations of the one or more objects, wherein a value at each respective location in the smoothed object center heatmap is higher than values in a proximate area of the location.

10. The method of claim 9, wherein smoothing the object center heatmap comprises applying a Gaussian filter having a standard deviation proportional to an object size.

11. The method of any of claim 9, wherein selecting the location further comprises filtering one or more locations at which the value in the smoothed object center heatmap is below a threshold.

12. The method of claim 1, wherein:
the first machine learning model includes a weight vector;
the feature map of the image comprises a plurality of samples each associated with a respective feature vector; and
a value of each sample in the object center heatmap is a dot product of a feature vector of a corresponding sample in the feature map and a weight vector.

13. The method of claim 1, wherein determining the feature map of the image comprises:
processing the image using a pre-trained neural network model to generate the feature map of the image.

14. The method of claim 1, further comprising capturing the image using a 1D barcode scanner or a 2D barcode scanner.

15. A non-transitory computer-readable media comprising instructions that, when executed by one or more processors on a computing device, are operable to cause the one or more processors to perform:
determining a feature map of the image;
processing the feature map of the image using a first machine learning model to generate an object center heatmap for the image, wherein the object center heatmap comprises a plurality of samples each having a value indicative of a likelihood of a corresponding sample in the image being a center of an object; and
determining locations of one or more objects in the image based on the object center heatmap.

16. A system comprising:
a scanner comprising an image capturing device configured to capture an image of a part on an inspection station; and
a processor configured to execute programming instructions to perform:
determining a feature map of the image;
processing the feature map of the image using a first machine learning model to generate an object center heatmap for the image, wherein the object center heatmap comprises a plurality of samples each having a value indicative of a likelihood of a corresponding sample in the image being a center of an object; and
determining locations of one or more objects in the image based on the object center heatmap.
